(19) United States
(12) Patent Application Publication
(10) Pub. No.: US 2016/0217372 A1
(43) Pub. Date: Jul. 28, 2016

(54) Billion Recounts of Events Ahead of Days

(71) Applicant: Anuthep Benja-Athon, New York, NY (US)

(72) Inventor: Anuthep Benja-Athon, New York, NY (US)

(21) Appl. No.: 14/606,956

(22) Filed: Jan. 27, 2015

(51) Int. Cl. G06N 5/02; H04L 29/08; G06F 17/30; G06Q 40/00

(52) U.S. Cl. CPC G06N 5/02; G06Q 40/12; H04L 67/32; G06F 17/30312

(57) ABSTRACT

A system and method for rendering adaptable electronic streams for modifying and controlling people's future through networked servers and communication devices wherein adaptable streams of continua of diverse data are rendered, shared and updated and individual continua are associated and adapted to render, update and adapt streams which are further disseminated, shared and updated in and among networked servers and communication devices.

### FIELD OF THE INVENTION

Networks for controlling people's future

### BACKGROUND OF THE INVENTION

The coming of the future of people is inevitable and daily. However, for better and worse, people heretofore were still in the dark age and, often, pain and suffering because almost all of their future are always daily surprises often beyond their control. However, the present invention provides the organized streams of electron in networks to enable billions of people to foresee thus modify and control their future to effect, improve and optimize almost all facets of their lives.

### SUMMARY OF THE INVENTION

Some albeit relatively small number of smart people have intuitions, forecasts, insights and predictions of future many of which are educated guesses based on learning and past experiences. So, billions of people heretofore passage into their future each time like their future are just infinite successive bends. Thus, most people are blind to their future wherein they are heretofore subjected constant surprises and adverse circumstances with deprivations and grave and deadly consequences.

The present invention is an artificial intelligence for foretelling people's future to billions of people in instant moments in perpetuity with immensely greater accuracy and reliability than human brains are capable of not to mention the fact that said artificial-intelligence-generated and updated foretells are rapidly and repeatedly rendered, disseminated, shared and updated by and among said billions through networks of servers, computers and mobile communication devices especially billions of smartphones.

The present invention is a system and method for rendering adaptable real-time electronic streams comprising continua of relational diverse data for modifying and controlling people's future through said networks wherein individual adaptable real-time streams of continua of diverse data are rendered, shared and updated and individual continua are further and repeatedly associated, adapted and updated—with and/or without real-time data being added—to render updated and adaptable real-time streams which are further or repeatedly disseminated, shared, edited, updated and recirculated among billions of networked servers and devices.

### DESCRIPTION OF THE PREFERRED EMBODIMENTS

The present invention provides the best artificial intelligence for perpetually and most efficiently generating and optimizing individual machine-composed insights, forecasts and predictions which are 24/7/365 viewed, used by and interact with billions of people.

Said artificial intelligence-generated and managed infinite insights, forecasts and predictions are infinitely more superior than those of human, the Oracle, the I Ching and the likes.

The present invention provides a system and method for generating and adapting electronic streams of foretells of future occurrences for foretelling, modifying and controlling people's future by the global networks of servers, computers and mobile communication devices especially billions of smartphones. Billions of people benefitted from the present invention as described herein.

The present invention comprised networked servers, computers and mobile communication devices including smartphones having viewing screens, rendering and requesting repositories and external interfaces for removably coupling to said networks, each of said repositories comprising processing means and storage means having attached innovative and smart computer programs comprising innovative apps and computer algorithms effecting the processes and objectives of the present invention described herein. In said repositories in said networks, a plurality of means for rendering are associated with relational data and logics in diverse data and relational diverse data among said repositories and processed by said processing means. Said associations are stored in said storage means.

First, said means for rendering individual streams comprise a plurality of selected groups of specific words, phrases, pictures, videos and any combinations thereof associating with relational data and logic in diverse data initially and smartly generated and gathered in a first server repositories and stored in the database in said storage means of said first server repositories. In said first server repositories, each of said groups of relational words, phrases, pictures and videos are smartly associated with a plurality of data and logics which are relational facts, meanings, concepts and principles in diverse data based on said computer algorithms. Said diverse data comprise structured and unstructured data, real-time data, texts, images, pictures, videos and said data in said streams having said data and logics.

It is to be understood, that said means for rendering individual streams also comprise said plurality of data and logic in said diverse data associating with said group and/or groups of words, phrases, pictures, videos and any combinations thereof based on said computer algorithms in said storage means and said first server repositories. Said associations are constantly enlarged, improved, edited and updated by repeating said processes—with or without new real-time data—in said first server repositories networked to networks of repositories.

Said processing means in said first server repositories and said networks of repositories repeat said processes for numerous to infinite associations fostered and represented by said associations including said first associations which are stored in said storage means of said networked repositories including said first server repositories. Consequently, 24/7/365 and infinite replications and improvements of said system and method to 24/7/365 produce, replicate, generate, enlarge, improve, edit, update said associations and associations and linkage of said associations which are stored in said networked repositories wherein infinite said adaptable electronic streams of continua of diverse data for foretelling future occurrences in and among networked server repositories, computer and device repositories are 24/7/365 generated, disseminated, pushed, shared and managed as described supra.

In passing, in each of said associations, said each diverse data—associating with said group and/or groups of relational words, phrases, pictures and videos—are smartly categorized and associated with diverse data such as, but not limited to, texts, pictures and videos in—as show in one of the many orders of relational data—continents<world regions<countries<sectors<subsectors<types<submission titles and identifications<diverse data> a group and groups of relational words, phrases, pictures, videos and combinations thereof, wherein “<” and “>” connote pointing in the relational database. Said relational database also included, but not limited to, dates, time, authors, contributors, writers, pseudonyms, pen-names, references, blogs and ratings. Said continents are such as, but not limited to, North America, South America, Asia, Europe, Australia and Africa.

Said regions are such as, but not limited to, North America, Central America, South America, Eurozone, Western Europe, Eastern Europe, Russia, Artics, Asia, Far East, South East Asia, South Asia, Australia, New Zealand, Antarctica, Middle East and Africa. Said sectors are, but not limited to, Consumer Discretionary, Consumer Staples, Global Economics, National Economics, Energy, Financials, Intelligence, National Politics, International Politics, Health Care, Industrials, Technology, Materials, Telecommunications, Living, Exploration, Security, Utilities. Said subsectors are such as, but not limited to, Agriculture, Governments, Congresses, Elections, National Elections, State Elections, Locality Elections, Pharmaceuticals, Immigration, Oceanography, Weather, Cultures, Religions, Celebrations, Festivities, Minings, Militaries, Upheavals. Said types are such as, but not limited to, breaking news, news, facts, rumors, insights, opinions and forecasts both rendered by said artificial intelligence and/or people especially said authors, contributors, writers, producers and users of said diverse data such as, but not limited to, texts, pictures and videos.

One of the preferred embodiments of the present invention is for said computer programs to instruct processing means of said networked repositories to organize the interactive, adaptable and editable viewing screen displays of continua of diverse data in the adaptable electronic streams based on said order albeit variations and adaptations can be had to suit any needs and requirements of said computers and devices.

Second, by disseminating and sharing said representative first associations in and among networked server repositories and computer and device repositories, consequently, billions of said processing means in said billions of networked rendering and requesting repositories processing said associations in said streams of continua in same said processes as those being applied by said first associations and stored said billions of associations including additions, editions and adaptions in billions said storage means based on said computer algorithms. Any data including real-time data and additions, editions and updates and unstructured data introduced into said networks will be processed and stored in said storage means in said networks as described supra.

Using said associations in said storage means in said networks, the computer programs having said algorithms to render individual adaptable electronic streams of foretells for modifying and controlling people's future. Said algorithms instructing said processing means in networked rendering and requesting repositories to process any requests by getting said associations of relational data in said to render individual viewable and editable streams comprising continua of diverse data which are viewable and editable in the viewing screens of said devices including smartphones having touchscreens wherein said diverse data are interactive with users. Said requesting repositories can add, edit and adapt said continua of diverse data by attaching additional data including real-time data to and edit and adapt said diverse data in said continua and storing said continua in said storage means. Consequently, said streams of data are repeatedly disseminated, circulated, added to, edited, adapt and shared among said networked servers, computers and devices. An example, an adaptable electronic streams of foretells of future occurrences will show continua displaying a representative scrollable ordered layout of relational texts, pictures and videos in one of the following representative orders: continents-specific, world regions-specific, countries-specific, sectors-specific, subsectors-specific, types-specific continuum of diverse data including, but not limited to, breaking news, news, facts, research, rumors, insights, opinions and forecasts and dates, time, authors, contributors, writers, producers of said diverse data, pseudonyms, pen-names, references, blogs and ratings of any and all the above. Said one representative order represents how said computer programs instructing said processing means how to organize said relational databases in said storage means from which said streams of continua of diverse data are rendered.

Third, said computer programs having said algorithms to instruct said repositories to target specific networked repositories to receive—by dissemination or push—specific said adaptable electronic streams based on generated means for rendering associating with specific identity data attaching to said specific targeted networked repositories to be said targets in said storage means.

Fourth, further by applying said data and databases in said networked repositories, said computer programs further instruct said processing means to associate or merge individual diverse data among said continua based on said algorithms to store in said storage means and to render, edit and update individual adaptable streams having said merged diverse data which are further disseminated, shared and updated in and among networked servers, computers and devices.

Said networked repositories disseminating and pushing said rendered continua of relational diverse data to networked and targeted repositories wherein said rendered continua are reciprocally adapted and edited by additions and deletions of data having relational data and logics and disseminated and pushed to said processor means processing and storing said associations in said storage means.

Further to supra, by said computer programs instructing said processing means in said networked repositories to repeat said processes to achieve expansions, updates and improvement of said outcomes whenever data are introduced into said networks, this machine artificial intelligence perpetually and infinitely repeat said processes to perpetually and most efficiently generate and optimize individual machine-composed insights, forecasts and predictions in said electronic streams of foretells of future occurrences on 24/7/365 and available to billions of people in any and all languages.

Said processing means calculating fee payments associating the usages of said streams by individual request repositories. Based on the fee payments, consequently, said processing means also calculated honorarium payments associating with said fee payments and said payments are deducted from individual financial accounts related to said individual request repositories or said honoraria are disbursed to individual financial accounts related to said authors, contributors, writers, producers of said diverse data, in particular, the breaking news, news, facts, insights, opinions and forecasts in said networked repositories. The use of email addresses of said authors, contributors, writers, producers and users of said texts, pictures and videos is one of the preferred embodiments for enabling electronic payments among said people in said networks.

In conclusion, never before in the history of mankind, the present invention rendering the infinite orderly streams of continua of diverse data being generated, advanced and updated in said networked servers, computers and communications devices for enabling billions of people, using networked communication devices, to foresee, modify and control their future to effect, improve and optimize almost all facets of all people's lives such as, but not limited to, health, decision makings, plans and endeavors such as, but not limited to, healthcare, business, investments, securities, travels, medicine, science, technologies and research, livings, quality and standard of living, livelihoods and longevity.

It is to be understood that many commercially available software(s) and hardware(s) will be applied and utilized to assist said innovative computer programs having innovative computer algorithms and associated apps—created by this applicant of this patent application—in said networked repositories to fulfill and achieve the objectives and goals of the present invention.

Although various preferred embodiments of the present invention have been described, it will be appreciated by those skilled in the art that adaptations, variations and derivatives of said embodiments are and will be made and achieved without departing from the spirit and scope of the specification of the present invention.

1. A system for rendering adaptable electronic streams of foretells of future occurrences and controlling the distributions and uses of said streams having attached a payments system through networks, said system having a mechanism for rendering and adapting said streams based on the associations of means for rendering said streams, said means for rendering specifying how continua of diverse data in said streams are composed and adapted and how real-time means for rendering and modifying said compositions in said continua and how said streams targeting individual request repositories for requesting said streams and each stream for specifying how fee and honorarium payments per request associating with request repositories are calculated based on computer algorithms in said networks, said system comprising:
computer programs having computer algorithms for instructing networked repositories how to process said associations of means for rendering to render and modify said streams based on associations with and without real-time data and diverse data of said associations and said associations with real-time data in said networks to render and adapt said streams and real-time data in said networks to render and adapt said streams to target request repositories and calculate and disburse fees payments associating the usages of said streams by individual request repositories and honoraria payments associating with said fees payments in said networks;
a plurality of networked servers, computers and mobile communication devices including smartphones having said repositories, said repositories are rendering and requesting repositories, each of said repositories comprising:
a plurality of external interfaces for removably coupling to said networks;
storage means for storing said means for rendering, diverse data, associations, said streams and continua and fees and honoraria schedules and related data;
processing means having attached said computer programs;
processing means for processing, rendering and adapting said means for rendering, associations, streams and continua and fees and honoraria payments and related data based on said computer algorithms;
processing means for calculating and storing data on fees payments associating with request repositories and honoraria payments associating with said fees payments in and among said repositories.

2. The system according to claim 1 wherein said diverse data comprise structured and unstructured data, real-time data, texts, images, pictures, videos and said data, breaking news, news, facts, rumors, insights, opinions and forecasts and continua of said diverse data and associations of diverse data in and among said continua.

3. The system according to claim 1 wherein said means for rendering said streams comprising a group or groups of words, phrases, pictures and videos associating with data and logic in diverse data in said storage means and said repositories based on said computer algorithms.

4. The system according to claim 1 wherein said means for rendering said streams comprising a plurality of relational data and logic in diverse data associating with said group or groups of words, phrases, pictures and videos in said storage means and said repositories based on said computer algorithms.

5. The system according to claim 1 wherein each of said adaptable streams comprises individual viewable and editable continua of said diverse data having said logics in said repositories and in the viewing screens of said computers and devices.

6. The system according to claim 1 wherein said plurality of viewable and editable continua in said repositories comprise most recent and up-to-date diverse data in said storage means and said repositories.

7. The system according to claim 1 wherein said individual real-time streams comprise individual viewable and editable continua of said diverse data in said repositories.

8. The system according to claim 1 wherein said individual real-time streams comprise individual viewable and editable continua of said diverse data specifically targeting said individual targeted requesting repositories.

9. The system according to claim 1 wherein said individual real-time streams comprise individual viewable and editable continua of said diverse data in said viewing screens.

10. In a system for rendering adaptable electronic streams of foretells of future occurences and controlling the distributions and uses of said streams having attached a payments system through networks, said rendering system comprised networked rendering and requesting repositories, said networked utilizing rendering computer programs for rendering and adapting said adaptable electronic streams comprising continua of diverse data in and among said repositories, a method for said networks modifying and controlling people's future by said adaptable electronic streams, said method comprising the steps of:
networking rendering servers, computers and mobile communication devices including smartphones comprising viewing screens and said rendering and requesting repositories having external interfaces for removably coupling to said networks, each of said repositories comprising processing means and storage means having attached said smart rendering computer programs comprising computer algorithms effecting the processes in the following steps;
processing means processing and rendering said first means for rendering by rendering the associations of a group or groups of words, phrases, pictures and videos with data and logics in diverse data being stored in said storage means in said rendering repositories;
processing means processing and rendering said first means for rendering by rendering the associations of relational data and logics in and among diverse data associating with a group or groups of words, phrases, pictures and videos in said storage means and said rendering repositories;
processing means rendering said streams comprising continua of relational diverse data by processing said associations in said storage means;
processing means rendering said streams comprising continua of relational diverse data by associating said associations associating with said continua in said streams in said storage means in networked repositories;
processing means rendering said streams comprising continua of diverse data by associating said associations associating with said continua associating with real-time data in said storage means in said networked repositories;
processing means in said networked repositories including said repositories having said processing means replicating and repeating said processes of processing numerous to infinite associations fostered and represented by said associations, the outcomes of said processings are stored in said storage means in said networked repositories;
said networked rendering repositories disseminating and pushing said streams of continua of relational diverse data to requesting and targeted repositories wherein said continua are reciprocally expanded, adapted and edited by additions with or without real-time data and deletions of data having relational data and logics and disseminated, shared and managed in and among said networked repositories; and
processor means calculating fees payments associating the usages of said streams by individual request repositories and honoraria payments associating with said fees payments which are disbursed to authors and contributors of the breaking news, news, facts, insights, opinions and forecasts by said repositories.

11. In a system for rendering adaptable electronic streams of foretells for modifying and controlling people's future through networks, a method for networked rendering and requesting repositories to render and adapt individual viewable and editable streams comprising continua of diverse data and to further associate individual continua and real-time diverse data to render updated and adaptable streams and to repeatedly disseminate, share and update said streams in and among networked rendering and requesting repositories, said method comprising the steps of:
networking rendering servers, computers and mobile communication devices including smartphones comprising viewing screens and said rendering and requesting repositories having external interfaces for removably coupling to said networks, each of said repositories comprising processing means and storage means having attached said smart rendering computer programs comprising computer algorithms effecting the processes in the following steps;
processing means processing and rendering said first means for rendering by rendering the associations of a group or groups of words, phrases, pictures and videos with data and logics in diverse data being stored in said storage means in said rendering repositories;
processing means processing and rendering said first means for rendering by rendering the associations of relational data and logics in and among diverse data associating with a group or groups of words, phrases, pictures and videos in said storage means and said rendering repositories;
processing means rendering said streams comprising continua of relational diverse data by processing said associations in said storage means;
processing means rendering said streams comprising continua of relational diverse data by associating said associations associating with said continua in said streams in said storage means in networked repositories;
processing means rendering said streams comprising continua of diverse data by associating said associations associating with said continua associating with real-time data in said storage means in said networked repositories;
processing means in said networked repositories including said repositories having said processing means replicating and repeating said processes of processing numerous to infinite associations fostered and represented by said associations, the outcomes of said processings are stored in said storage means in said networked repositories;
said networked rendering repositories disseminating and pushing said streams of continua of relational diverse data to requesting and targeted repositories wherein said continua are reciprocally expanded, adapted and edited by additions with or without real-time data and deletions of data having relational data and logics and disseminated, shared and managed in and among said networked repositories; and
processor means calculating fees payments associating the usages of said streams by individual request repositories and honoraria payments associating with said fees payments which are disbursed to authors and contributors of the breaking news, news, facts, insights, opinions and forecasts by said repositories.
